(19) United States
(12) Patent Application Publication
(10) Pub. No.: US 2005/0178492 A1
(43) Pub. Date: Aug. 18, 2005

(54) Method for producing spacer for flat panel display

(75) Inventors: Keiko Kubo, Tokyo (JP); Atsushi Hitomi, Tokyo (JP); Yukio Kawaguchi, Tokyo (JP); Hiroaki Sawada, Tokyo (JP); Mio Hosokawa, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/059,577

(22) Filed: Feb. 16, 2005

(30) Foreign Application Priority Data
Feb. 17, 2004 (JP) 2004-039315
Dec. 28, 2004 (JP) 2004-378482
Dec. 28, 2004 (JP) 2004-378483

(51) Int. Cl. C04B 33/32

(52) U.S. Cl. 156/89.16; 264/650; 264/656

(57) ABSTRACT

By minimizing polishing after sintering, there provided a method for producing a spacer for a flat panel display, which can reduce the processing man-hour and processing cost. A green sheet is prepared from a slurry including a predetermined raw material powder and a binder, the binder is removed from the green sheet, and the binder removed green sheet is sintered with a loading member loaded thereon, which has a surface of a predetermined flatness contacting the green sheet. Preferably, the spacer contains TiC and/or TiO₂ and Al₂O₃ with a composition consisting essentially of 5.0 to 16.0 mol % of TiC, 0.5 to 20.0 mol % of TiO₂, and the balance being substantially Al₂O₃, or contains TiC and/or TiO₂, MgO and Al₂O₃ with a composition consisting essentially of 5.0 to 16.0 mol % of TiC, 0.5 to 20.0 mol % of TiO₂, 80.0 mol % or less of MgO and the balance being substantially Al₂O₃.

### BACKGROUND OF THE INVENTION

1. Field of the Invention

The present invention relates to a method suitable for producing a spacer for a flat panel display using a sheet method.

2. Description of the Related Art

Thin and light flat displays are known as displays alternative to bulky and heavy cathode ray tubes (CRT). Field emission displays (FED) are known as one type of flat displays. The FED is a self-luminous flat display applying a conventional CRT, and its principle of display of images is similar to that of the CRT. The FED comprises a cathode structure having a large number of cathodes (field emission elements) arranged in a two-dimensional form, in which electrons emitted from the cathodes under an environment of reduced pressure (e.g. 10⁻⁵ Torr or less) are accelerated and collided against targeted fluorescent pixel areas to form a luminous image (e.g. Japanese Patent Laid-Open No. 2001-68042).

The FED comprises two flat glass base plates: a back plate comprising a cathode structure emitting electrons and a face plate comprising fluorescent pixel areas, and the width of a space between the two glass base plates is approximately 0.1 to 3 mm. The space between the two glass base plates is kept at a reduced pressure of, for example, 10⁻⁵ Torr or less as described above, and therefore the surfaces of the two glass base plates are exposed to atmospheric pressure. Thus, a pressure resistant structure (hereinafter referred to spacer) to counter atmospheric pressure is placed between the two glass base plates so that the space between the two glass base plates is maintained (e.g. Japanese Patent Laid-Open No. 2001-68042).

There exist several types of spacers, and one of them is a strip spacer. The strip spacer is positioned perpendicularly between the face plate and back plate. The spacer is required to be positioned between fluorescent pixels. The spacer is required to have a strength sufficient to endure a strong compressive force received from the face plate and the back plate. A high level of dimensional accuracy is required for each spacer. Moreover, the spacer should have a coefficient of thermal expansion close to that of the glass base plate constituting the face plate and the back plate. If an arrangement of spacers gets out of order due to the compressive force or other factor, emitted electrons are deflected, and thus visible defects are raised on a display. Since a high voltage of, for example, 1 kV or greater is applied to between the face plate and the back plate, the spacer is required to have a resistance to a high voltage and lower secondary emission characteristics.

As conventional spacers, those obtained by coating insulating materials made of alumina (Al₂O₃) with conductive materials and those made of ceramics having transition metal oxides dispersed therein (e.g. National Publication of International Patent Application No. 1999-500856) are known.

As described above, the spacer is made of ceramics, and therefore inevitably requires a step of sintering. For example, in National Publication of International Patent Application No. 2002-515133, a slurry is produced by mixing together a ceramics powder, an organic binder and a solvent, the slurry is formed into a green sheet, and the binder is removed from the green sheet, followed by sintering to produce a spacer. However, a sheet method in which the sheet is fabricated and then sintered in this way has a problem such that warpage tends to occur during sintering if the sheet has a small thickness of approximately 100 to 350 μm. If warpage occurs, a desired flatness cannot be obtained even if polishing is performed, or much time is required for polishing.

Thus, the object of the present invention is to provide a method for producing a spacer for a flat panel display which can reduce the processing man-hour and processing cost by minimizing polishing after sintering.

### SUMMARY OF THE INVENTION

The inventor sintered a green sheet with a flat member loaded thereon and as a result, occurrence of warpage could be inhibited. The present invention is based on the result of studies described above, and is a method for producing a spacer for a flat panel display wherein a green sheet is prepared from a slurry including a predetermined raw material powder and a binder, the binder is removed from the green sheet, and the green sheet having the binder removed therefrom is sintered together with a loading member loaded thereon, wherein the loading member has a surface of a predetermined flatness contacting the green sheet.

In the present invention, the spacer for a flat panel display preferably comprises a sintered body containing TiC and/or TiO₂ and Al₂O₃, and having a composition consisting essentially of 5.0 to 16.0 mol % of TiC, 0.5 to 20.0 mol % of TiO₂, and the balance substantially being Al₂O₃.

In the present invention, the spacer also preferably comprises a sintered body containing TiC and/or TiO₂, MgO and Al₂O₃ and having a composition consisting essentially of 5.0 to 16.0 mol % of TiC, 0.5 to 20.0 mol % of TiO₂, 80.0 mol % or less (excluding 0) of MgO and the balance substantially being Al₂O₃.

For these sintered bodys, a resistivity of 1.0×10⁶ to 1.0×10¹¹ Ω·cm, which is preferable as a spacer for a flat panel display, can easily be obtained. For the sintered body, other physical properties are favorable as a spacer for a flat panel display.

The loading member in the present invention may have various configurations, but the surface contacting the green sheet preferably has an area at least equal to the surface area of the green sheet. The loading member is preferably loaded such that it covers the total surface of the green sheet.

For the loading member in the present invention, the Rmax (defined in JIS(Japan Industrial standard) doc. #B0601) of the surface contacting the green sheet is preferably 3 to 60 μm. If so, bonding to the sintered body is prevented, and the surface of the sintered body is flattened.

The loading member in the present invention is preferably comprised of a material having a melting point of 1800° C. or higher. If so, a reaction with the sintered body is prevented in a sintering step.

Binder removal (Binder burn-out) is carried out with the green sheet heated to a predetermined temperature, for example about 350 to 450° C., but when the binder removal is completed, binding of ceramics powder particles by the binder is released. The inventors found that the green sheet after binder removal is thus extremely fragile. If the green sheet after binder removal is fragile, care should be taken so that the green sheet does not get out of shape during transportation from a furnace in which binder removal has been carried out to a furnace for sintering, for example. Of course, such a problem is avoided if binder removal and sintering are carried out in the same furnace, but in some cases, binder removal and sintering are carried out in different furnaces in terms of production procedure, production equipment and production efficiency. Thus, it is desired that the green sheet after binder removal should have a strength sufficient to maintain a predetermined shape during transportation from the binder removal furnace to the sintering furnace, namely collapse resistance. Furthermore, the green sheet should have a collapse resistance for bearing a flat member. In this way, the collapse resistance is a factor required for coping with handling such as transportation after binder removal and also obtaining a spacer having an excellent flatness. Particularly, a ceramics composition containing MgO is found to have collapsability as shown in Examples described later, and it is necessary that a collapse resistance should be secured for such a composition.

The present invention proposes that the collapse resistance important for production of spacers is obtained by carrying out a heat treatment subsequent to binder removal. That is, in the present invention, the green sheet can be sintered together with a loading member loaded thereon, wherein the loading member has a surface of a predetermined flatness contacting the green sheet, after a heat treatment for improving the interparticle binding force of a ceramic raw material powder contained in the green sheet having the binder removed therefrom is carried out.

According to the present invention, the heat treatment for improving the interparticle binding force of the ceramic raw material powder contained in the green sheet is carried out after binder removal and before sintering. Owing to the heat treatment, the green sheet can have a collapse resistance. The green sheet having a collapse resistance has improved handling characteristics, and never collapses even if a member for prevention of warpage during sintering is loaded thereon. Here, in the present invention, binder removal and the heat treatment can be carried out in succession, and this practice is preferable for the present invention. This is because if an excessive stress is applied after binder removal, the green sheet may collapse.

In the method for producing a spacer for a flat panel display according to the present invention, the heat treatment for improving the interparticle binding force of a ceramic raw material powder is carried out at a temperature in a mid-range between a temperature range for binder removal and a temperature range for sintering. More specifically, binder removal is carried out in a temperature range of 200 to 600° C., and sintering is carried out in a temperature range of 1400 to 1750° C. The heat treatment of the present invention is carried out preferably in a temperature range of 800 to 1300° C. By carrying out the heat treatment at a temperature in the range described above, the interparticle binding force of a ceramic raw material powder is improved compared to the condition immediately after binder removal, and a collapse resistance can be imparted to the green sheet. Binder removal and the heat treatment can be carried out in succession as described previously and in this case, the green sheet is kept in a temperature range of 200 to 600° C. for a predetermined time period to complete binder removal, then left intact while elevating the temperature, and kept in a temperature range of 800 to 1300° C. for a predetermined time period.

A method for imparting a collapse resistance to the green sheet can be applied to the method for producing a spacer for a flat panel display irrespective of whether a loading member is loaded on the green sheet or not. Thus, the present invention provides a method for producing a spacer for a flat panel display, comprising the steps of: fabricating a green sheet from a slurry including a ceramic raw material powder and a binder; subjecting the green sheet to a treatment for removal of the binder; carrying out a heat treatment for improving the interparticle binding force of the ceramic raw material contained in the green sheet subjected to the treatment for removal of the binder; and sintering the green sheet subjected to the heat treatment.

In this method for producing a spacer for a flat panel display, the treatment for removal of the binder and the heat treatment can be carried out in succession. Likewise, the green sheet subjected to the heat treatment can be sintered together with a loading member loaded thereon, wherein the loading member has a surface of a predetermined flatness contacting the green sheet.

In this method for producing a spacer for a flat panel display, the treatment for removal of the binder can be carried out in a temperature range of 200 to 600° C., the heat treatment can be carried out in a temperature range of 800 to 1300° C., and sintering can be carried out in a temperature range of 1400 to 1750° C.

In this method for producing a spacer for a flat panel display, it is particularly effective that the spacer comprises a sintered body containing TiC and/or TiO₂, MgO and Al₂O₃, and having a composition consisting essentially of 5.0 to 16.0 mol % of TiC, 0.5 to 20.0 mol % of TiO₂, 80.0 mol % or less (excluding 0) of MgO and the balance substantially being Al₂O₃. This is because collapsability becomes noticeable if MgO is contained.

The present invention also provides a method for producing a spacer for a flat panel display, comprising the steps of fabricating a green sheet from a slurry including a ceramic raw material powder and a binder; heating the green sheet to a temperature of 200 to 600° C. to remove the binder; heating to a temperature of 800 to 1300° C. the green sheet subjected to the treatment for removal of the binder; and sintering the green sheet subjected to the heat treatment in a temperature range of 1400 to 1750° C.

In this method for producing a spacer for a flat panel display, the treatment for removal of the binder and the heat treatment can be carried out in succession. Likewise, the green sheet subjected to the heat treatment can be sintered together with a loading member loaded thereon, wherein the loading member has a surface of a predetermined flatness contacting the green sheet.

As described above, according to the present invention, the man-hour for polishing after sintering can be reduced, and the production cost can be reduced in production of a spacer for a flat panel display.

According to the present invention, a collapse resistance can be imparted to the green sheet in a stage after binder removal and before sintering. The green sheet having the collapse resistance has excellent handling characteristics. The green sheet having the collapse resistance can be loaded thereon with a loading member for inhibiting occurrence of warpage during sintering. The present invention is particularly effective for ceramics compositions containing MgO, for which collapsability has been observed.

### BRIEF DESCRIPTION OF THE DRAWINGS

FIG. 1 is a flowchart showing production steps of the present invention;

FIG. 2 is a plan view of an FED;

FIG. 3 is a sectional view of a part shown by the arrow II-II in FIG. 2;

FIG. 4 is a perspective view showing a spacer;

FIG. 5 is a side view showing an internal structure on the FED face plate side;

FIG. 6 shows an example of a heating profile of binder removal, heat treatment and sintering of the present invention;

FIG. 7 shows an example of the heating profile of binder removal, heat treatment and sintering of the present invention;

FIG. 8 shows resistivity of a sintered body sintered at 1550° C. in Example 1;

FIG. 9 shows resistivity of a sintered body sintered at 1600° C. in Example 1;

FIG. 10 shows the results of heat treatment conditions, collapse resistance and existence/nonexistence of deformation;

FIG. 11 shows appearances of wafers undergoing a collapse resistance test; and

FIG. 12 shows resistivity of a sintered body sintered at 1600° C. in Example 1;

### DETAILED DESCRIPTION OF THE PREFERRED EMBODIMENTS

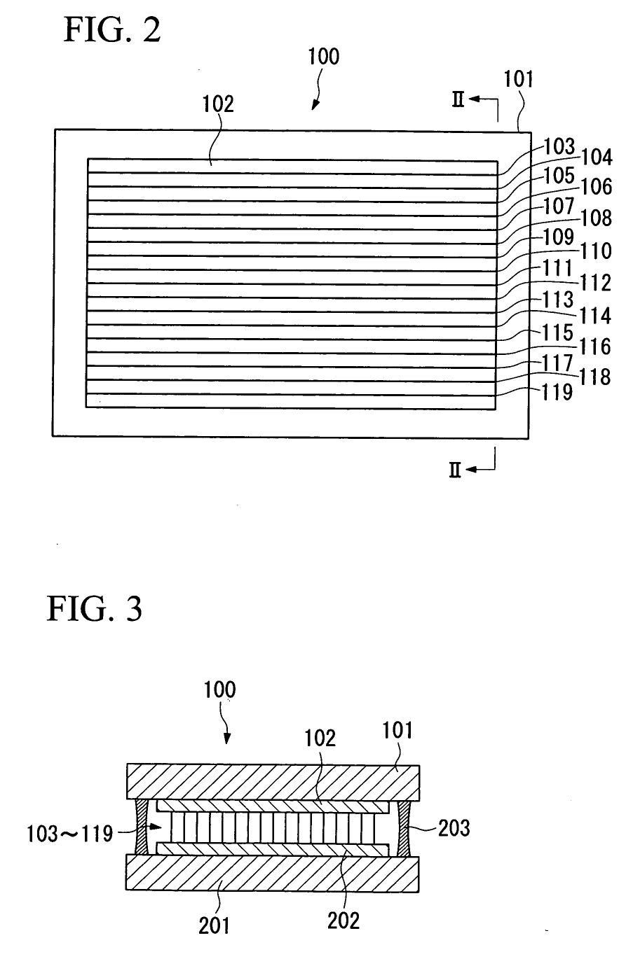

First, an embodiment of an FED and an FED spacer, to which the present invention is applied, will be described. FIG. 2 is a plan view of the FED and FIG. 3 is a sectional view of a part shown by the arrow II-II in FIG. 2.

In FIGS. 2 and 3, an FED (field emission display) 100 comprises a face plate 101 made of glass, and a back plate 201 placed at a predetermined space from the face plate 101, and spacers 103 to 119 makes equal the space between the face plate 101 and the back plate 201.

A black matrix structure 102 is formed on the face plate 101 made of glass. The black matrix structure 102 includes a plurality of fluorescent pixel areas composed of phosphorous layers. The phosphorous layer emits light to form a visible display when high energy electrons collides the phosphorous layer. Light emitted from a specific fluorescent pixel area is made to outgo via the black matrix structure 102. The black matrix is a lattice black structure for inhibiting mixture of light from mutually neighboring fluorescent pixel areas.

On the face plate 101, the back plate 201 is placed via spacers 103 to 119 (103, 104, 105, 106, 107, 108, 109, 110, 111, 112, 113, 114, 115, 116, 117, 118 and 119) constituting a wall suspended from the surface of the face plate 101. The surface of an active area of the back plate 201 has a cathode structure 202. The cathode structure 202 has a plurality of raised portions (field (electron) emission elements) for emitting electrons.

The area on which the cathode structure 202 is formed is smaller than the area of the back plate 201. A glass seal 203 formed by, for example, a molten glass frit exists between the outer periphery of the face plate 101 and the outer periphery of the back plate 201, whereby a sealed chamber is formed at the center. The interior of the sealed chamber is decompressed to the extent that electrons can travel in space. The cathode structure 202, the black matrix structure 102 and the spacers 103 to 119 will be placed in the sealed chamber.

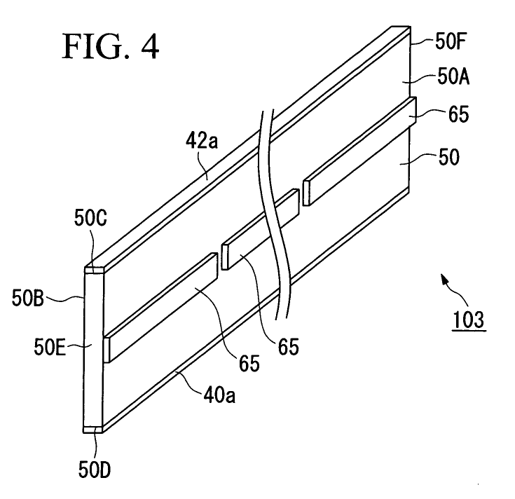

A perspective view of the spacer 103 (104 to 119) is shown in FIG. 4. The spacer 103 (104 to 119) has main surfaces 50A and 50B being front and back surfaces of a base 50, side faces 50C and 50D extending along the longer direction, and edge faces 50E and 50F at both ends in the longer direction. A patterned metal film 65 is formed on the main surface 50A, and metal films 42a and 40a are formed on the side faces 50C and 50D, respectively. The metal film 65 is divided into a plurality of sections and extends along the longer direction of the spacer 103 (104 to 119). The metal film 65 is kept separated from the metal films 42a and 40a to the extent that insulation can be provided therebetween.

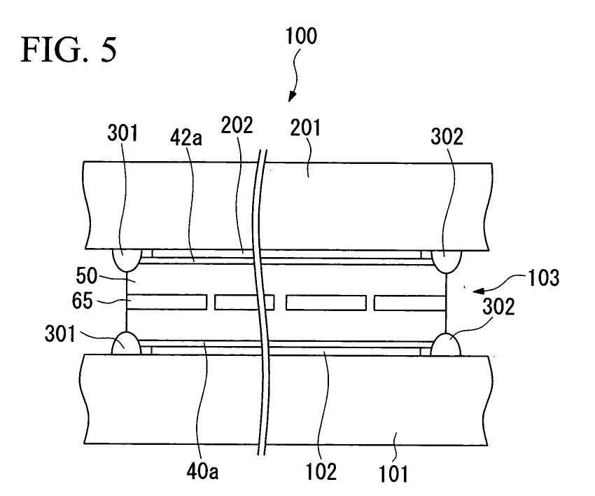

As shown in FIG. 5, the spacer 103 (104 to 119) is fixed to the face plate 101 and the back plate 210 by adhesives 301 and 302 provided along the longer direction. For the adhesives 301 and 302, an ultraviolet curable adhesive, thermoset adhesive or inorganic adhesive may be used. The adhesives 301 and 302 are placed outside the black matrix structure 102 and the cathode structure 202. In this case, the metal films 40a and 42a of the spacer 103 contact the cathode structure 202 of the back plate 201 and the black matrix structure 102 of the face plate 101, respectively.

The spacer 103 (104 to 119) according to the present invention can be formed from a ceramics sintered body containing TiC and/or TiO₂, i.e. one or both of TiC and TiO₂, and Al₂O₃, or a ceramics sintered body further containing MgO.

The ceramics sintered body containing TiC and/or TiO₂, and Al₂O₃ preferably has a composition consisting essentially of 5.0 to 16.0 mol % of TiC, 0.5 to 20.0 mol % of TiO₂, and the balance substantially being Al₂O₃. However, the amount of TiO₂ is preferably adjusted depending on whether TiC is contained or not, and the content of TiO₂ is preferably 0.5 to 20.0 mol % if TiC is not contained. If TiC is contained, the content thereof is preferably 0.5 to 4.0 mol %.

If the content of TiC and/or TiO₂ is not within the range described above, resistivity may significantly decrease before the field reaches 10000 V/mm.

Further, it may be difficult to obtain a resistivity of 1.0×10⁶ to 1.0×10¹¹ Ω·cm, which is suitable as a spacer. If resistivity is smaller than 1.0×10^{6 Ω·cm, an overcurrent may pass, resulting in thermal runaway. If resistivity is greater than} 1.0×10¹¹ Ω·cm, electrical charging may tend to occur, resulting in distortion of images.

In the ceramics sintered body of the present invention, a part or all of TiC and/or TiO₂ can be substituted by TiN.

The ceramics sintered body containing TiC and/or TiO₂, Al₂O₃ and MgO preferably has a composition in which the content of TiC is 5.0 to 16.0 mol %, the content of TiO₂ is 0.5 to 20.0 mol %, the content of MgO is 80.0 mol % or less (excluding 0) and the Al₂O₃ substantially makes up the balance. In this case, the amount of TiO₂ is preferably adjusted depending on whether TiC is contained or not as described above.

The coefficient of thermal expansion of this sintered body can be adjusted by changing the content of MgO. The sintered body contains MgAl₂O₄ and MgO in its microstructure. The coefficient of thermal expansion is 8.1×10⁻⁶/° C. (40 to 400° C.) for MgAl₂O₄ and 12.1×10⁻⁶/° C. (20 to 300° C.) for MgO, and thus the coefficients of thermal expansion of both MgAl₂O₄ and MgO are greater than that of Al₂O₃, i.e. 6.2×10⁻⁶/° C. (0 to 300° C.).

MgO can be incorporated in any amount according to a required coefficient of thermal expansion, but if the amount of MgO is greater than 80 mol %, the strength of the spacer tends to be decreased. In this sintered body, a part or all of TiC and/or TiO₂ can be substituted by TiN.

The sintered body described above constitutes a conductive ceramics having a high hardness (Hv: 15 to 30 GPa) and a high strength (three-point bending strength: 250 to 750 Mpa), and can be resistant to deformation by a compressive force during use of a flat display. Thus the spacer for a flat display using the sintered body can inhibit distortion of images.

By changing the composition of TiC and TiO₂ within the range described above, a sintered body having a resistivity of about 1.0×10⁶ to 1.0×10¹¹ Ω·cm can easily be obtained. The spacer for a flat display using the sintered body shows a desired resistivity is hard to be electrically charged, and has inhibited thermal runaway resulting from passage of an overcurrent. Thus, the spacer for a flat display using the sintered body can inhibit distortion of images in the flat display.

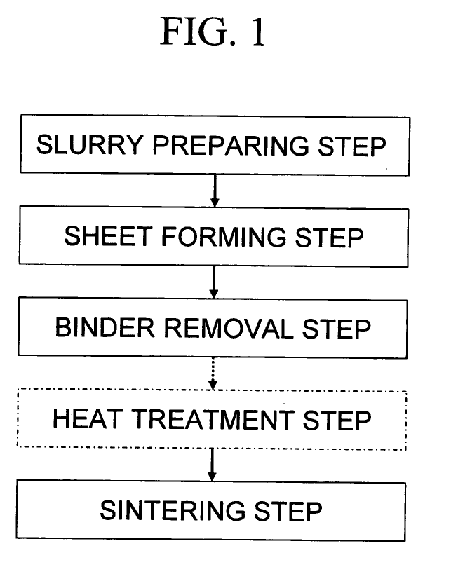

A method for producing a spacer according to the present invention will now be described. The method for producing a spacer according to the present invention comprises a slurry producing step, a sheet forming step, a binder removal step and a sintering step as shown in FIG. 1. The present invention can comprise a heat treatment step between the binder removal step and the sintering step. Suitable examples for the steps will be described below. The description below is only illustrative.

<Slurry Preparing Step>

In this step, a slurry for forming a sheet is prepared.

As a raw material powder for a sintered body, a TiC powder, a TiO₂ powder, an Al₂O₃ powder, and an MgO powder as required are prepared. The raw material powders are weighed and mixed so as to obtain the composition described above, and then mixed and milled by a wet process using, for example, a ball mill or the like. The mixing and milling is continued until the mean particle size becomes approximately 0.1 to 3 μm. The powder mixed and milled by a wet process is dried to obtain a raw material powder for slurry.

A binder, a dispersant, a plasticizer and a solvent are added to and mixed with the raw material powder for slurry to prepare a slurry for forming a sheet. For the mixing, well known mixing means such as a ball mill may be used. For the binder, a well known binder such as ethyl cellulose, acryl resin or butyral resin may be used. For the dispersant, a sorbitan fatty acid ester or glycerin fatty acid ester may be added. For the plasticizer, dioctyl phthalate, dibutyl phthalate or butyl phthalyl butyl glycolate may be used. For the solvent, a well-known solvent such as terpineol, butyl carbitol or kerosene maybe used. By using part of the solvent for slurry for dispersion media in a step of mixing and milling the raw material, the slurry can be prepared without drying after the mixing and milling step. The amounts of binder, dispersant, plasticizer and solvent to be added are not specifically limited, but it is recommended that the amount should be 1 to 10 wt % for the binder, 0.1 to 5 wt % for the dispersant, 0.5 to 10 wt % for the plasticizer, and 20 to 70 wt % for the solvent.

<Sheet Forming Step>

The slurry obtained as described above is coated on a film such as a polyester film by, for example, the doctor blade method and dried to fabricate a green sheet. The green sheet should have a thickness of approximately 100 to 350 μm. The green sheet may be formed by stacking a plurality of thin green sheets. The green sheet may be formed as a structure having an ultimately desired width, or may be formed as a structure having a width larger than an ultimately desired width and cut into a wafer (green sheet) having a predetermined width.

<Binder Removal Step>

In the binder removal step, the binder contained in the obtained green sheet is removed. In the binder removal step, the green sheet is held at a temperature in the range of 200 to 600° C. for 0.5 to 20 hours. If the heating temperature is less than 200° C. or the holding time is less than 0.5 hours, removal of the binder is insufficient. If the heating temperature is higher than 600° C., oxidation becomes noticeable. If the holding time is longer than 20 hours, removal of the binder is almost completed, and thus an effect matching energy consumption for heating and holding cannot be obtained. Thus, the green sheet is preferably held in a temperature range of 200 to 600° C. for 0.5 to 20 hours for binder removal. The temperature range for binder removal is preferably 300 to 500° C., further preferably 350 to 450° C. The holding time in binder removal is preferably 1 to 15 hours, further preferably 2 to 10 hours.

If TiC is added, the atmosphere in which binder removal is carried out is preferably an atmosphere of a law oxygen partial pressure for preventing decomposition of TiC, at the same time promoting removal of the binder. For example, it may be an atmosphere with a water vapor introduced into a mixed gas of hydrogen and nitrogen.

<Heat Treatment Step>

In the present invention, the green sheet subjected to binder removal can be subjected to a heat treatment before the sintering step. The heat treatment step will be described below.

Since a flat member is loaded on the sheet, the sheet may collapse after binder removal, so that subsequent sintering cannot be carried out. Thus, the green sheet subjected to binder removal should have a collapse resistance. Thus, the heat treatment is carried out subsequent to binder removal to impart the collapse resistance.

After the binder removal step is completed, the green sheet subjected to binder removal is subjected to the heat treatment. The heat treatment improves the interparticle binding force of the ceramic raw material powder constituting the green sheet subjected to binder removal. Owing to the heat treatment, diffusion of elements among particles or slight sintering proceeds, whereby binding between particles is induced. Thus the heat treatment imparts a collapse resistance to the green sheet.

For inducing binding between particles, the green sheet is preferably heated and held in a temperature range of 800 to 1300° C. in this heat treatment. The heat treatment at a temperature lower than 800° C. cannot sufficiently improve the interparticle binding force of the raw material powder. If the temperature is higher than 1300° C., a reaction similar to sintering occurs, and warpage may occur in the green sheet (sintered body). Thus, the temperature in the heat treatment should be 800 to 1300° C. The heat treatment temperature is more preferably 900 to 1300° C., further preferably 1000 to 1250° C. An optimum heat treatment temperature should be appropriately determined according to the composition of ceramics as a matter of course.

The heat treating time for holding the green sheet in a temperature range of 800 to 1300° C. is preferably 1 to 20 hours. If the time is less than 1 hour, the force of binding of the raw material powder cannot be sufficiently improved. If the temperature is in the range of 800 to 1300° C., the force of binding of the raw material powder can be sufficiently improved by holding the green sheet for about 20 hours. The holding time in the heat treatment is preferably 1 to 10 hours, further preferably 2 to 8 hours.

It is desirable that the heat treatment in the present invention should be carried out in succession from binder removal. Here, the succession means that it is required that the binder removal and heat treatment should be carried out in a same processing furnace. This is because the green sheet after binder removal may collapse if it is moved. The succession means that it is required that the temperature should be elevated to a temperature necessary for the heat treatment without decreasing the temperature after completion of heating and holding at a temperature in a predetermined range for binder removal. This is because if the temperature is temporarily decreased after binder removal, energy efficiency is reduced. However, the present invention does not necessarily require that the binder removal and heat treatment should be carried out in succession.

The sintered body containing MgO may noticeably be fragile after binder removal for reasons that are not clear, and therefore the heat treatment described above is effective when the spacer 103 (104 to 119) composed of a ceramics sintered body containing TiC and/or TiO₂, Al₂O₃ and MgO is fabricated.

<Sintering Step>

The green sheet subjected to the binder removal or heat treatment is then sintered. For sintering, the green sheet may be held in a temperature range of 1400 to 1750° C. If the temperature is less than 1400° C., sintering does not sufficiently proceed, and if the temperature is higher than 1750° C., grain growth advances so far that the strength is reduced. The sintering temperature is preferably 1500 to 1700° C. The heating and holding time in sintering may be appropriately selected from 1 to 12 hours according to the heating and holding temperature. Sintering does not sufficiently proceed if the holding time is less than 1 hour, and it cannot be expected that sintering proceeds farther even if the holding time exceeds 12 hours. The heating and holding time is preferably 2 to 8 hours. Sintering may be carried out in a vacuum or inert gas atmosphere such as atmosphere of nitrogen gas or reducing atmosphere such as mixture of hydrogen and nitrogen gases. The resistivity of the sintered body can be changed by changing the sintering temperature and sintering time.

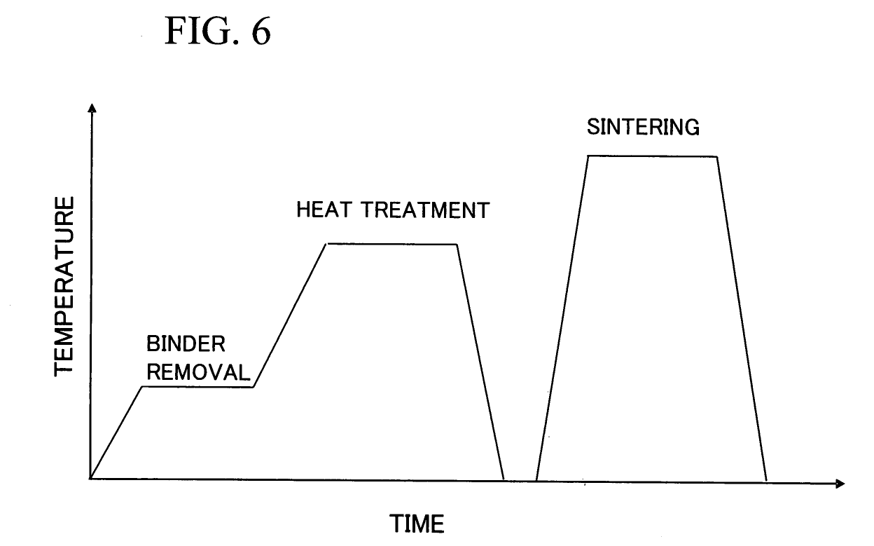

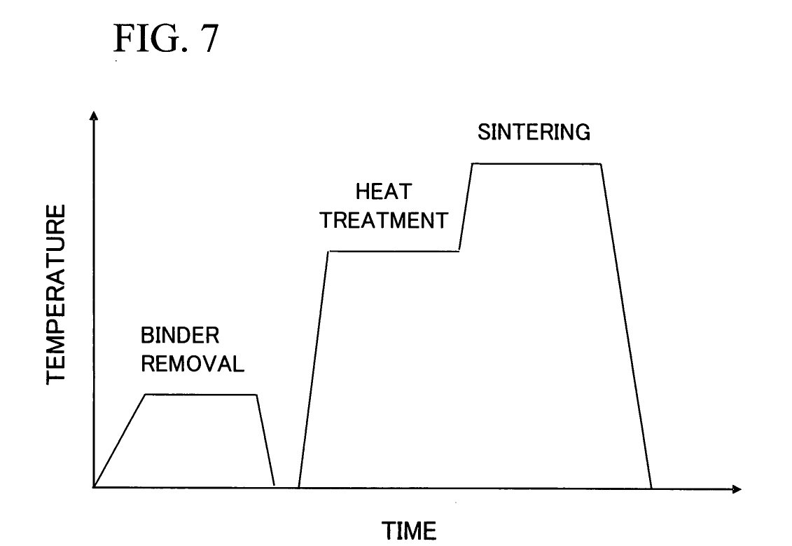

A series of heating patterns of binder removal, heat treatment and sintering is shown in FIGS. 6 and 7. The present invention includes a configuration in which after the binder removal and heat treatment are carried out in succession and completed, sintering is carried out independently as shown in FIG. 6. The present invention includes a configuration in which after binder removal is completed, the heat treatment and sintering are carried out in succession.

In the present invention, a flat member for preventing occurrence of warpage during sintering is loaded on the green sheet before sintering. In this member, a surface contacting the green sheet has a predetermined flatness. Hereinafter, the member will be referred to as a cover. The cover is preferably composed of a high-melting point material having a melting point of 1800° C. or higher for preventing occurrence of a reaction with a sintering object material in the sintering process. In the present invention, high-melting point metals such as W (melting point: 3387° C.), Ta (melting point: 2996° C.), Nb (melting point: 2467° C.) and Mo (melting point: 2623° C.), and high-melting point compounds such as Al₂O₃ (melting point: 2020° C.), ZrO₂ (melting point: 2680° C.) and BN (melting point: 2730° C.) may be used.

It is desirable that the cover in the present invention preferably has an area equal to or greater than that of the green sheet. This is because covering the entire surface of the green sheet with the cover is preferable for obtaining a flat sintered body. Either one cover or two or more covers may be loaded on the green sheet. Alternatively, one cover may be loaded on two or more green sheets. When the cover is loaded, an approximately uniform stress is applied to the sintering object material (green sheet-sintered body) in a direction in which occurrence of warpage is inhibited.

For this cover, the surface in contact with the green sheet should be prevented from being extremely flattened in order to prevent sticking to the sintering object material during sintering. However, if the contact surface is too rough, the roughness may be transferred to the sintered body. From the standpoint described above, the contact surface of the cover preferably has a surface roughness Rmax of approximately 3 to 60 μm.

The sintered body has its surface polished, then the metal films 65, 42a and 40a are formed by a normal process to form the spacer 103 (104 to 119).

### EXAMPLE 1

The present invention will be described below based on specific Examples.

A TiC powder (mean particle size: approximately 0.5 μm, the content of carbon is 19% or greater, of which 1% or less is represented by free graphite), a TiO₂ powder (mean particle size: approximately 1.7 μm) and an Al₂O₃ powder (mean particle size: approximately 0.5 μm) were weighed to TiC: 11.70 mol %, TiO₂: 1.81 mol % and Al₂O₃: 86.49 mol %, and the powders were milled and mixed by a wet process using a ball mill to obtain a raw material powder for slurry.

A binder, a dispersant, a plasticizer and a solvent were added to the raw material powder for slurry according to the details described below, and they were mixed by a ball mill to prepare a slurry for forming a sheet.

binder: polyvinyl butyral resin . . . 3 wt %

dispersant: graft polymer anionic dispersant . . . 2 wt %

plasticizer: phthalate (e.g. BPBG) . . . 3 wt %

solvent: alcohol (e.g. ethanol)+aromatic solvent (e.g. toluene) . . . 51.25 wt %

The slurry thus obtained was used to fabricate a green sheet having a thickness of approximately 250 μm by the doctor blade method, and the green sheet was cut to obtain a test wafer having a width of 56 mm and a length of 65 mm. For removing the contained binder, the wafer was subjected to binder removal in which the wafer was held at 400° C. for 2 hours in an atmosphere of a mixed gas of 1% of hydrogen and 99% of nitrogen while a water vapor having a dew point of 35° C. was introduced thereinto.

The wafer subjected to binder removal was sintered. For sintering, the wafer was placed on a setter made of Al₂O₃, and a cover made of Al₂O₃ was placed on the wafer for maintaining a flatness equal to that of the green sheet. The cover, which had a width of 56 mm and a length of 65 mm (thickness of 2.5 mm) like the wafer, was placed on the wafer such that the peripheral edge of the cover matched that of the wafer. The setter and the cover were flat, and each had a surface roughness Rmax of 10 to 20 μm.

The wafer was sintered in the state described above. Sintering was carried out by holding the wafer in a vacuum for 2 hours at 1550° C., 1600° C. and 1650° C., respectively (Example).

The flatness of the sintered body (thickness: 200 μm) was measured, and it was found that the flatness Rmax was 60 μm or less (per scanning length of 50 mm) for all of temperatures 1550° C., 1600° C. and 1650° C. For comparison, the flatness of the sintered body was measured for an example in which no cover was placed (Comparative Example). As a result, significant warpage which could be visually observed occurred. In this way, a spacer for FED having an excellent flatness can be fabricated by placing a cover before sintering.

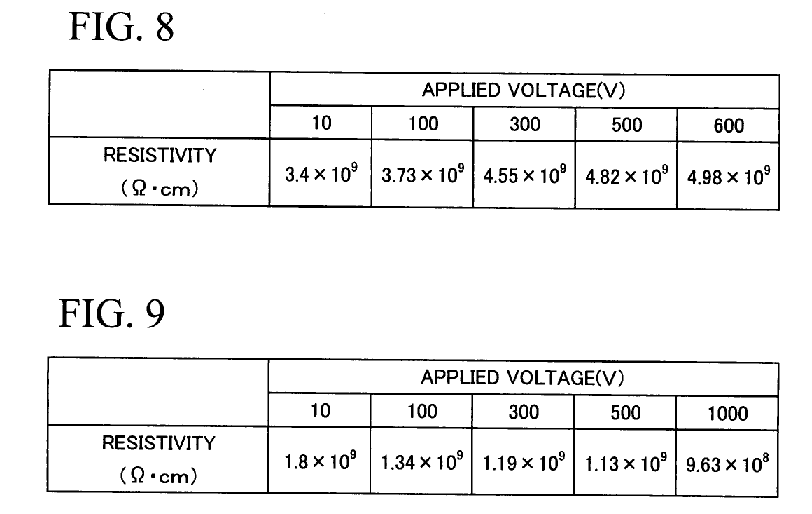

Resistivity was measured for Example (sintering temperature: 1550° C.). The results are shown in FIG. 8, and it was found that the resistivity was in a range preferable as a spacer, i.e. 1.0×10⁶ to 1.0×10¹¹ Ω·cm.

Resistivity for a sintered body was obtained in the same manner as described above except that the sintering temperature was changed (sintering temperature: 1600° C.). The results are shown in FIG. 9, and it was found that the resistivity was in a range preferable as a spacer, i.e. 1.0×10⁶ to 1.0×10¹¹ Ω·cm.

### EXAMPLE 2

An Al₂O₃ powder (mean particle size: approximately 0.5 μm), a TiO₂ powder (mean particle size: approximately 1.7 μm) and an MgO powder (mean particle size: approximately 5.8 μm) were weighed to Al₂O₃: 30.38 mol %, TiO₂: 12.51 mol % and MgO: 57.11 mol %, and the powders were milled and mixed by a wet process using a ball mill to obtain a raw material powder for slurry.

A binder, a dispersant, a plasticizer and a solvent were added to the raw material powder for slurry according to the details described below, and they were mixed by a ball mill to prepare a slurry for forming a sheet.

binder: polyvinyl butyral resin . . . 3 wt %

dispersant: graft polymer anionic dispersant . . . 2 wt %

plasticizer: phthalate (e.g. BPBG) . . . 3 wt %

solvent: alcohol (e.g. ethanol)+aromatic solvent (e.g. toluene) . . . 51.25 wt %

The slurry thus obtained was used to fabricate a green sheet having a thickness of approximately 150 μm by the doctor blade method, and the green sheet was cut to obtain a test wafer having a width of 56 mm and a length of 65 mm. For removing the contained binder, the wafer was subjected to binder removal in which the wafer was held at 400° C. for 8 hours in an atmosphere of nitrogen gas while a water vapor having a dew point of 35° C. was introduced into a tubular furnace.

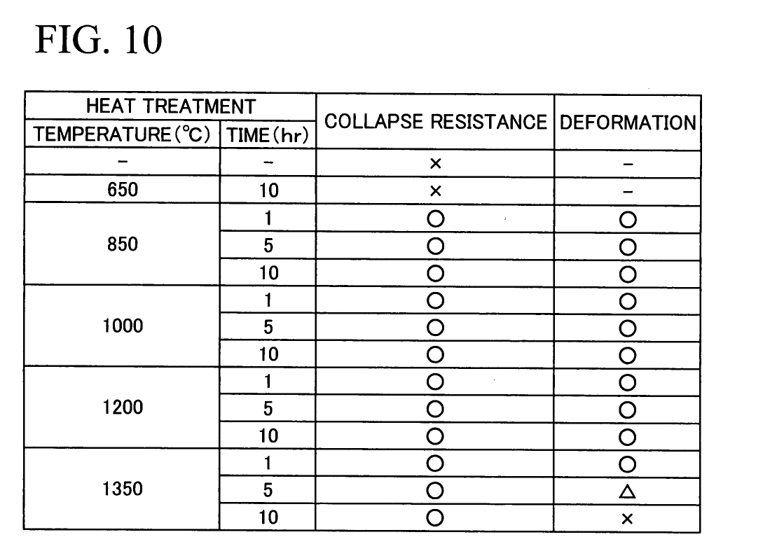

After the binder removal was completed, heat treatment was carried out by heating the tubular furnace to the respective temperatures shown in FIG. 10, and holding the wafers at those temperatures for the respective time periods shown in FIG. 10. After binder removal was completed, introduction of the water vapor having a dew point of 35° C. was stopped to bring the interior of the tubular furnace into an atmosphere of nitrogen gas.

The collapse resistance of the wafer subjected to the heat treatment described above was observed. A cover having a size same as that of the wafer: a width of 56 mm and a length of 65 mm (thickness of 2.5 mm) was placed on the wafer, and the collapse resistance was determined according to whether the wafer could maintain its shape or not. The cover was flat, and its surface flatness Rmax was 3 to 60 μm. A wafer that could maintain its shape is rated ◯ as a wafer having a collapse resistance, and a wafer that could not maintain its shape is rated x in FIG. 10.

Whether the wafer subjected to the heat treatment described above was deformed or not was determined. The determination was made on the basis of whether warpage of 60 μm or greater in Rmax occurred or not. A wafer with warpage less than 60 μm (per scanning length of 50 mm) is rated ◯, and a wafer with warpage of 60 μm or greater is rated x in FIG. 10.

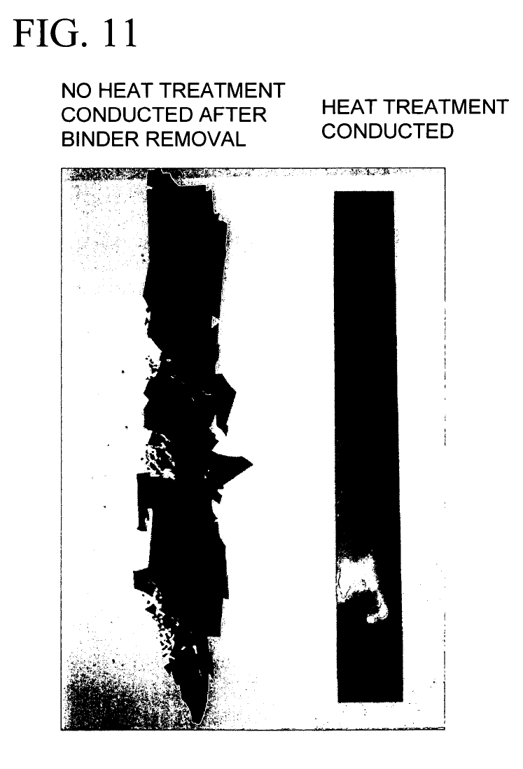

As shown in FIG. 10, wafers not subjected to the heat treatment after binder removal and wafers subjected to the heat treatment at 650° C. have no collapse resistance. Appearances after the collapse resistance test for wafers not subjected to the heat treatment after binder removal and wafers subjected to the heat treatment of holding the wafer at 1200° C. for 5 hours are shown in FIG. 11.

If the heat treatment temperature is 1350° C., the wafer has a collapse resistance, but sintering proceeds, and the level of warpage is no longer negligible. Thus, it can be understood that the heat treatment temperature is preferably 800 to 1300° C.

The wafer subjected to the heat treatment of holding the wafer at 1200° C. for 5 hours was placed on a setter made of Mo, and a cover made of Mo as described above was placed on the wafer for maintaining a flatness equal to that of the green sheet. The cover, which had a width of 56 mm and a length of 65 mm (thickness of 2.5 mm) like the wafer, was placed on the wafer such that the peripheral edge of the cover matched that of the wafer. The setter was flat, and the surface in contact with the wafer had a roughness Rmax of 3 to 60 μm. The wafer was sintered in the state described above. Sintering was carried out by holding the wafer in an atmosphere of N₂ gas for 2 hours at 1550° C., 1600° C. and 1650° C., respectively (Example).

The flatness of the sintered body (thickness: 100 μm) was measured, and it was found that the flatness Rmax was 60 μm or less (per scanning length of 50 mm) for all of temperatures 1550° C., 1600° C. and 1650° C. For comparison, the flatness of the sintered body was measured for an example in which no cover was placed (Comparative Example). As a result, significant warpage which could be visually observed occurred. In this way, a spacer for FED having an excellent flatness can be fabricated by placing a cover before sintering.

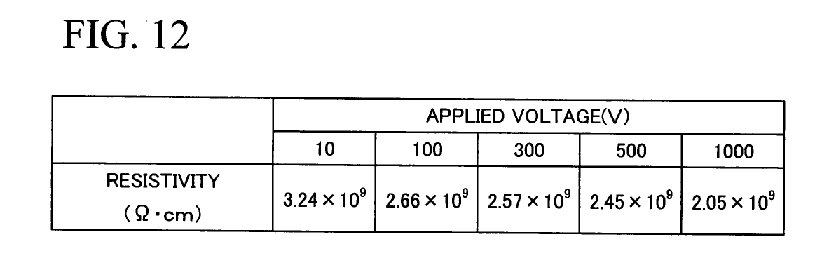

Resistivity was measured for Example (sintering temperature: 1600° C.). The results are shown in FIG. 12, and it was found that the resistivity was in a range preferable as a spacer, i.e. 1.0×10⁶ to 1.0×10¹¹ Ω·cm.

1. A method for producing a spacer for a flat panel display, comprising the steps of:
preparing a green sheet from a slurry including a predetermined raw material powder and a binder;
removing said binder from said green sheet; and
sintering said green sheet having said binder removed therefrom with a loading member loaded thereon, wherein said loading member has a surface of a predetermined flatness contacting said green sheet.

2. The method for producing a spacer for a flat panel display according to claim 1, wherein:
said spacer comprises a sintered body containing TiC and/or TiO₂ and Al₂O₃, and having a composition consisting essentially of 5.0 to 16.0 mol % of TiC, 0.5 to 20.0 mol % of TiO₂, and the balance substantially being Al₂O₃.

3. The method for producing a spacer for a flat panel display according to claim 1, wherein:
said spacer comprises a sintered body containing TiC and/or TiO₂, MgO and Al₂O₃, and having a composition consisting essentially of 5.0 to 16.0 mol % of TiC, 0.5 to 20.0 mol % of TiO₂, 80.0 mol % or less (excluding 0) of MgO and the balance substantially being Al₂O₃.

4. The method for producing a spacer for a flat panel display according to claim 1, wherein:
said sintered body has a resistivity of 1.0×10⁶ to 1.0×10¹¹ Ω·cm.

5. The method for producing a spacer for a flat panel display according to claim 1, wherein:
said loading member having the surface contacting said green sheet and the area at least equal to that of said green sheet is loaded on said green sheet such that said loading member covers the entire surface of said green sheet.

6. The method for producing a spacer for a flat panel display according to claim 1, wherein:
the Rmax of the surface of said loading member contacting said green sheet is 3 to 60 μm.

7. The method for producing a spacer for a flat panel display according to claim 1, wherein:
said loading member is composed of a material having a melting point of 1,800° C. or higher.

8. The method for producing a spacer for a flat panel display according to claim 1, wherein:
said green sheet having said binder removed therefrom is subjected to a heat treatment for improving the interparticle binding force of said ceramic raw material powder contained in said green sheet,
after said heat treatment, said green sheet is sintered with said loading member loaded thereon.

9. The method for producing a spacer for a flat panel display according to claim 8, wherein:
the treatment for removing said binder and said heat treatment are carried out in succession.

10. The method for producing as pacer for a flat panel display according to claim 8, wherein:
said treatment for removing said binder is carried out in a temperature range of 200 to 600° C.;
said heat treatment is carried out in a temperature range of 800 to 1300° C.; and
said sintering is carried out in a temperature range of 1400 to 1750° C.

11. A method for producing a spacer for a flat panel display, comprising the steps of:
preparing a green sheet from a slurry including a ceramic raw material powder and a binder;
removing said binder from said green;
carrying out a heat treatment for improving the interparticle binding force of said ceramic raw material powder contained in said green sheet subjected to the treatment for removing said binder; and
sintering said green sheet subjected to said heat treatment.

12. The method for producing a spacer for a flat panel display according to claim 11, wherein:
said treatment for removing said binder and said heat treatment are carried out in succession.

13. The method for producing a spacer for a flat panel display according to claim 11, wherein:
said treatment for removing said binder is carried out in a temperature range of 200 to 600° C.;
said heat treatment is carried out in a temperature range of 800 to 1300° C.; and
said sintering is carried out in a temperature range of 1400 to 1750° C.

14. The method for producing a spacer for a flat panel display according to claim 11, wherein:
said spacer comprises a sintered body containing TiC and/or TiO₂, MgO and Al₂O₃, and having a composition consisting essentially of 5.0 to 16.0 mol % of TiC, 0.5 to 20.0 mol % of TiO₂, 80.0 mol % or less (excluding 0) of MgO and the balance substantially being Al₂O₃.

15. A method for producing a spacer for a flat panel display, comprising the steps of:
preparing a green sheet from a slurry including a ceramic raw material powder and a binder;
removing said binder from said green sheet by heating said green sheet in a temperature range of 200 to 600° C.;
heat treating said green sheet subjected to the treatment for removing said binder in a temperature range of 800 to 1300° C.; and
sintering said green sheet subjected to said heat treatment in a temperature range of 1400 to 1750° C.

16. The method for producing a spacer for a flat panel display according to claim 15, wherein:
the treatment for removing said binder and said heat treatment are carried out in succession.
